(19) United States
(12) Patent Application Publication
(10) Pub. No.: US 2003/0034465 A1
(43) Pub. Date: Feb. 20, 2003

(54) Gate valve actuator with universal mounting arrangement

(75) Inventors: Keith M. Adams, Katy, TX (US); Todd J. Mosley, Houston, TX (US); Davy G. Pampell, Houston, TX (US); Kennard W. Taylor, Spring, TX (US)

Correspondence Address: COOPER CAMERON CORPORATION, 13013 NORTHWEST FREEWAY, PO BOX 1212 (77251-1212), HOUSTON, TX, 77040, US

(73) Assignee: Cooper Cameron Corporation

(21) Appl. No.: 09/930,681

(22) Filed: Aug. 15, 2001

(51) Int. Cl. F16K 31/00

(52) U.S. Cl. 251/14

(57) ABSTRACT

A gate valve actuator that utilizes a mounting ring interposed between the valve bonnet and actuator housing to allow the mounting of different sizes and types of gate valve actuators onto a given gate valve and providing rotation with respect thereto is disclosed. A split retainer ring allows the coupling between the actuator and valve bonnet to avoid the use of bolts subject to corrosion and failure. A first embodiment uses a pneumatically operated diaphragm to provide a force for opening the valve. Other embodiments use pneumatically and hydraulically powered pistons. Another embodiment shows the use of multiple springs to augment the closing force.

### BACKGROUND OF THE INVENTION

1. Field of the Invention

This invention relates to a pneumatically actuated diaphragm or piston linear gate valve actuator and a hydraulically actuated piston linear gate valve actuator that is operated between a first position in which fluid flows through the valve bore and a second position in which the valve bore is closed. Such valve actuators have a variety of applications in the oil and gas industry. Additionally, an embodiment applicable to a hydraulically actuated gate valve actuator is disclosed.

Gate valve actuators are used to remotely control the opening and closing of gate valves commonly used in the oil and gas industry. Remote control of these valves is often desirable due to safety concerns or relative inaccessibility of the valve for manual operation. Additionally, when such gate valve actuators are used, they may be used to control and operate groups of gate valves together to reduce personnel requirements or control the flow of oil and gas from a group of oil and gas producing wells. It is imperative that such gate valve actuators operate dependably and allow certain operational features.

The gate valves that these gate valve actuators are operating generally consist of a valve with a through bore concentric with inlet and outlet passages. The flow of fluid such as oil or gas through the valve is controlled by a slab of material or gate as it is commonly referred to in the industry. This gate is slidable vertically by the aforementioned actuator. In the open position, a bore in the gate aligns with the inlet and outlet passages to allow oil and gas to flow through the valve. Such gates are typically referred to as reverse acting gates, i.e., when the actuator moves the gate, typically upward, away from the valve bore to the closed position, the bore in the gate moves out of alignment with the inlet and outlet passages and flow is stopped. The actuator is biased to move the gate to the closed position and the valve is referred to as a reverse acting gate valve or fail closed gate valve. A valve designed to fail open is accomplished with a gate having the bore moved inwardly or more closely to the end of the gate, referred to as a direct acting gate valve. Seal rings, usually positioned in the inlet and outlet passages adjacent the gate, ensure effective sealing and no leakage through the valve.

These valve actuators use pneumatic or hydraulic operating pressure to move the gate to its open position. This operating pressure typically operates a diaphragm or piston to supply the force needed to hold the gate in the open position. A powerful spring is positioned in the actuator housing and is compressed by the movement of the diaphragm or piston. The energy or force stored in the compressed spring will force the gate to its closed position when operating pressure is removed from the diaphragm or piston. This ensures the valve will fail safe closed in the event operating pressure is lost. These springs typically are compressed initially during assembly of the valve actuator. It would be desirable to have a mechanism incorporated in the design of the actuator that would allow easy compression of this spring without requiring specialized spring compression assembly tools.

It is desirable to be able to remove the actuator from the gate valve, even when the gate valve is in the closed position and containing pressure, for maintenance or repair. Additionally, the operating pressure to operate the actuator is often supplied through hard or rigid piping. This arrangement requires the actuator to be oriented to a certain position to allow connection. It is therefore desirable for the actuator to be able to rotate to any position to allow connection to the hard piping.

2. Description of Related Art

U.S. Pat. No. 3,958,592 to R. E. Wells et al. shows a pneumatic gate valve actuator with control chamber seals designed to disintegrate in a fire and allow spring pressure to close the valve.

A pneumatic gate valve actuator utilizing a toroidal or tire casing shaped pressure chamber is disclosed in U.S. Pat. No. 4,783,046 to T. G. Young et al.

U.S. Pat. No. 4,967,785 to T. G. Young shows a gate valve actuator having a variable volume.

A hydraulic gate valve actuator or booster module for use in cutting wireline in a valve bore during closing is disclosed in U.S. Pat. No. 5,178,360 to T. G. Young.

U.S. Pat. No. 6,089,531 to T. G. Young shows pneumatic and hydraulic gate valve actuators that allow removal of the valve actuators without disturbing the bonnet stem drift adjustment.

### SUMMARY OF THE INVENTION

The present invention comprises a gate valve actuator that utilizes a universal mounting ring interposed between the valve bonnet and actuator housing to allow the mounting of different sizes and types of gate valve actuators onto a given gate valve. A first embodiment of the present invention uses a pneumatically operated diaphragm. The valve actuator comprises an actuator housing connected to a valve bonnet through a universal mounting ring for coupling the actuator to a valve. The valve bonnet includes a valve stem bore extending there through and a seal assembly disposed around the periphery of the valve stem bore for sealing a valve stem extending through the valve bonnet.

The actuator housing includes upper and lower sections that are sealing bolted together. The upper section of the actuator housing includes a cap nut welded into the upper section and an indicator stem extending therethrough. The lower end of the indicator stem is sealingly secured to a diaphragm support plate by a retainer nut. The flexible rubber diaphragm extends radially outwardly where it is secured between the upper and lower sections of the actuator housing. A fluid port allows introduction of pressurized fluid into the pressure chamber thus formed.

The diaphragm support plate can move downward and contact the power screw which is threaded into the stem adapter that is threaded onto the upper end of the valve stem. A large coil spring is positioned around the stem adapter and valve stem. The upper end of the coil spring bears against a spring retainer plate that is retained on the stem adapter by a flange on the exterior of the power screw. When the power screw is threaded into the stem adapter, the spring retainer plate compresses the spring. The lower end of the spring sits on a shoulder in the valve bonnet.

An annular seal is positioned in the valve bonnet bore and retained therein by a seal retainer nut. The exterior of the valve bonnet adjacent the actuator housing has an external thread formed thereon. A mounting ring having an internal thread is threaded onto the external thread of the valve bonnet. The actuator housing lower section has a counterbore formed therein and the counterbore is sized to closely engage the exterior of the mounting ring. A retainer groove is machined in the counterbore of the actuator housing lower section and an outwardly biased retainer ring is positioned in the retainer groove to secure the actuator housing to the mounting ring.

A secondary backup is provided in the form of a solid backup ring positioned adjacent the retainer ring when the retainer ring is outwardly biased to prevent inward movement of the retainer ring. The solid backup ring is secured to the mounting ring by retainer bolts. A plurality of set screws is radially positioned in the mounting ring and engages the valve bonnet to prevent rotation of the mounting ring relative to the valve bonnet. Additionally, a plurality of set screws is radially positioned in the actuator housing and engages the mounting ring to prevent rotation of the actuator housing relative to the mounting ring. When it is desired to rotate the actuator housing relative to the valve bonnet, to aid in alignment of the valve actuator housing with adjacent piping, the aforementioned set screws can be loosened and the actuator housing rotated to the desired position.

Additional embodiments are shown. A second embodiment utilizes a second spring positioned around the first spring to provide a greater closing force. A third embodiment utilizes an annular piston in place of the diaphragm to provide the pneumatic force required to open the valve. A final embodiment utilizes a hydraulically actuated valve actuator that provides the same rotation and anti-tampering characteristics as the pneumatic actuators.

A principal object of the present invention is to provide a valve actuator for use with gate valves with a fully rotatable connection between the actuator and valve bonnet without the need for bolts that are susceptible to corrosion.

Another object of the present invention is to provide a valve actuator with a rotatable connection between the valve actuator and valve to allow orienting the valve actuator's pressure supply port in any desired direction without actuator disassembly.

A final object of the present invention is to provide a valve actuator with a power screw incorporated into its design to allow compression of the actuator urging means or spring without requiring specialized valve actuator assembly tools.

These with other objects and advantages of the present invention are pointed out with specificness in the claims annexed hereto and form a part of this disclosure. A full and complete understanding of the invention may be had by reference to the accompanying drawings and description of the preferred embodiments.

### BRIEF DESCRIPTION OF THE DRAWINGS

These and other objects and advantages of the present invention are set forth below and further made clear by reference to the drawings, wherein:

FIG. 1 is an elevation view, partially in section, of a pneumatically actuated diaphragm type valve actuator embodying the present invention.

FIG. 2 is an elevation view, partially exploded, showing the power screw of the present invention.

FIG. 3 is an elevation view, partially in section, of a pneumatically actuated diaphragm type valve actuator with an additional power spring embodying the present invention.

FIG. 4 is an elevation view, partially in section, of a pneumatically actuated piston type valve actuator embodying the present invention.

FIGS. 5A and 5B are an elevation view, partially in section, of a hydraulically actuated piston type valve actuator embodying the present invention.

### DESCRIPTION OF THE PREFERRED EMBODIMENTS

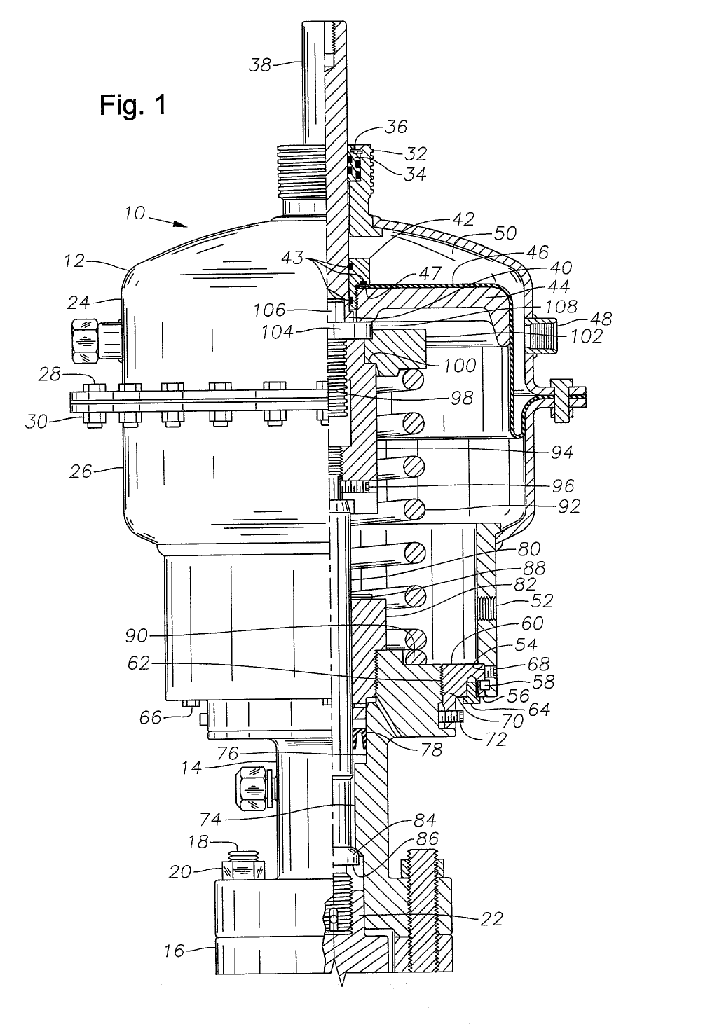

With reference to the drawings, and particularly to FIG. 1, an elevation view, partly in section, of a valve actuator 10 embodying the principles of the present invention is shown. Valve actuator 10 comprises actuator housing 12 secured to valve bonnet 14. Valve bonnet 14 is secured to gate valve 16 (shown in partial section) by suitable securing means as studs 18 and nuts 20. Gate valve 16 is of a conventional configuration well known to those of ordinary skill in the art with valve gate 22 movable therein between open and closed positions by valve actuator 10. Valve gate 22 is typically a reverse acting gate, i.e., when the actuator moves the gate, typically upward, away from the valve bore to the closed position, the bore in the gate moves out of alignment with the inlet and outlet passages and flow is stopped. Such a valve is referred to as a reverse acting gate valve or fail closed gate valve. A valve designed to fail open is accomplished with a gate having the bore moved inwardly or more closely to the end of the gate, referred to as a direct acting gate valve. Either configuration may be used with the actuator of the present invention without departing from the scope of the invention.

Actuator housing 12 is a generally cylindrical member composed of upper section 24 and lower section 26. Upper section 24 and lower section 26 have integrally formed flanges on their periphery and are secured together by suitable securing means as bolts 28 and nuts 30. Upper section 24 is a domed structure with cap nut 32 welded into the top. Cap nut 32 is counterbored to receive sealing means in the form of seal assembly 34 that is inserted in cap nut 32 and retained by snap ring 36. Seal assembly 34 seals against indicator stem 38 which extends through cap nut 32. The lower end of indicator stem 38 has a flange 40 formed thereon. Retainer nut 42 in threaded into diaphragm support plate 44 and prevents indicator stem 38 from pulling through diaphragm support plate 44. O rings 43 positioned on the interior of retainer nut 42 seal against indicator stem 38.

Diaphragm support plate 44 has flexible diaphragm 46 attached to its upper face by retainer nut 42. Diaphragm 46 seals against diaphragm support plate 44. The inner edge of flexible diaphragm 46 has metal ring 47 molded therein which in turn seals against O ring 43 when retainer nut 42 is tightened. The outer edge of flexible diaphragm 46 is sealingly secured between upper section 24 and lower section 26 by bolts 28 and nuts 30. The combination of flexible diaphragm 46 sealed between upper section 24 and lower section 26, sealed to support plate 44 and the sealing of cap nut 32 to indicator stem 38 forms pressure chamber 50. Flexible diaphragm 46 and diaphragm support plate 44 form a pressure responsive member that is moveable toward gate valve 16 in response to pressurized fluid, i.e., compressed air introduced into pressure chamber 50 through fluid port 48 welded into the wall of upper section 24.

Actuator housing lower section 26 includes an exhaust port 52 machined in its lower portion allowing air to be exhausted from actuator housing 12 when pressure chamber 50 is pressurized and flexible diaphragm 46 and diaphragm support plate 44 move toward gate valve 16. The end of actuator housing lower section 26 has a counterbore 54 machined therein. Formed in counterbore 54 is retainer groove 56 with outwardly biased retainer ring 58 therein. Retainer ring 58 is a generally “C” shaped ring of square cross-section. Retainer ring 58 is machined to fit tightly within retainer groove 56 in its relaxed condition. Adjacent counterbore 54 of actuator housing lower section 26 is mounting ring 60.

Mounting ring 60 has internal thread 62 formed on its interior and its exterior is machined to fit closely within counterbore 54 of actuator housing lower section 26. As seen in FIG. 1, when mounting ring 60 engages counterbore 54 and retainer ring 58 is in place, the overlap of retainer ring 58 with the edge of mounting ring 60 locks actuator housing 12 to mounting ring 60. At the same time, this configuration allows the rotation of actuator housing 12 to any desired position to allow connection of piping (not shown) to fluid port 48. Although retainer ring 58 is in its relaxed position in retainer groove 56 as noted above, a backup system is provided to ensure actuator housing 12 cannot be uncoupled from mounting ring 60 unintentionally. This includes solid support ring 64 of “L” shaped cross-section that is secured to mounting ring 60 by suitable securing means as retainer bolts 66. Support ring 64 ensures retainer ring 58 cannot be contracted inwardly and thereby release actuator housing 12 from mounting ring 60 unintentionally. A plurality of set screws 68 are threaded through actuator housing lower section 26 to contact mounting ring 60 and prevent relative movement between actuator housing 12 and mounting ring 60.

Adjacent mounting ring 60 and radially inward is valve bonnet 14. Valve bonnet 14 has exterior thread 70 on its upper end that is engaged by internal thread 62 of mounting ring 60 to secure mounting ring 60 and hence actuator housing 12 to valve bonnet 14. Valve bonnet 14 is secured by gate valve 16 as previously noted. The use of exterior thread 70 on valve bonnet 14 in combination with mounting ring 60 allows an operator to use different size and types of actuators on a given valve by simply using a mounting ring sized to fit between valve bonnet 14 and a given valve actuator. This allows an operator to use a larger actuator when pressure loads so dictate. A plurality of set screws 72 are threaded through mounting ring 60 to contact valve bonnet 14 and prevent relative movement between valve bonnet 14 and mounting ring 60.

Valve bonnet 14 has bore 74 extending therethrough with counterbore 76 at its upper end. Seal ring 78 is positioned in counterbore 76 to seal against actuator stem 80 extending therethrough. Seal 78 is secured within counterbore 76 by seal retaining nut 82 threaded into valve bonnet 14. Actuator stem 80 includes enlarged diameter 84 that engages shoulder 86 of valve bonnet 14 to limit axial movement of actuator stem 80 with respect to valve 14 and hence gate valve 16. Shims 88 in the form of annular rings are positioned on seal retaining nut 82 to set the downward movement limit of actuator 12 and ensure the bore in valve gate 22 aligns with the inlet and outlet passages in gate valve 16 in a manner well known to those of ordinary skill in the art. A recess 90 is formed in the upper end of valve bonnet to locate and centralize urging means or actuator spring 92.

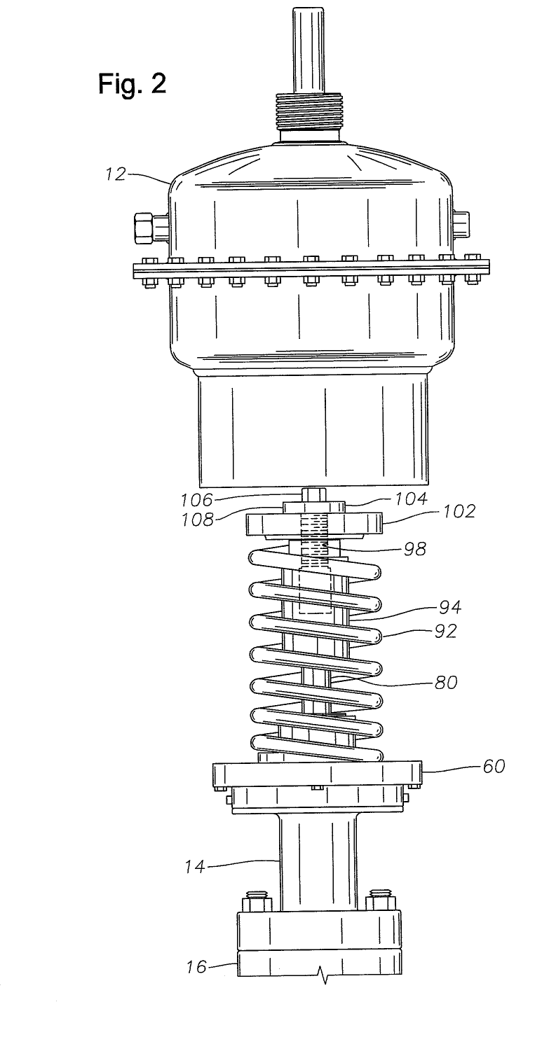

Secured to the outer end of actuator stem 80 is stem adapter 94. Stem adapter 94 is sized to shoulder against actuator stem 80 and form a rigid connection therebetween. Stem adapter 94 is locked against rotation with respect to actuator stem 80 by set screws 96. Stem adapter 94 is counterbored with thread 98 machined therein. The upper exterior of stem adapter 94 has step 100 machined thereon upon which urging means or spring retainer 102 rests. Engaging thread 98 of stem adapter 94 is power screw 104. Power screw 104 has a hex 106 formed on its upper end for engagement by a wrench to allow threading power screw 104 into stem adapter 94. Power screw 104 also has flange 108 on its upper end to engage spring retainer 102. As best seen in FIG. 2, when power screw 104 initially engages thread 98 of stem adapter 94, spring 92 is uncompressed. As power screw 104 is threaded into stem adapter 94, flange 108 of power screw 104 acts on spring retainer 102 to compress spring 92, thereby avoiding the need for special tools during assembly and allowing quick and easy assembly and disassembly of the actuator.

The sequence of operation for the gate valve 16 and valve actuator 10 is as follows. In the position shown in FIG. 1, pressure chamber 50 is at ambient pressure and spring 92 has pushed upwardly on spring retainer 102 to move valve gate 22 to its upper or closed position. When it is desired to open gate valve 16, pressurized fluid is supplied to pressure chamber 50. This pressure acts on diaphragm 46 to force diaphragm support plate 44 into contact with power screw 104 and thereby compress spring 92. This forces stem adapter 94 and actuator stem 80 to move downwardly thereby opening gate valve 16. As long as pressure is maintained in pressure chamber 50, gate valve 16 will remain open. In this pressurized condition, the pressure applied in pressure chamber 50 acts to try and pull actuator housing 12 away from mounting ring 60. As noted previously, this load is resisted by retainer ring 58. When retainer ring 58 is thus loaded, this large force creates sufficient friction between retainer ring 58, retainer groove 56 and mounting ring 60 to ensure that it is virtually impossible for retainer ring 58 to be retracted and thereby ensure actuator housing 12 is locked to mounting ring 60. When pressure is released from pressure chamber 50, spring 92 moves valve gate 22 to its closed position and the aforementioned large load on retainer ring 58 is relieved and retainer ring 58 may be retracted should it be desired to remove actuator housing 12 from mounting ring 60.

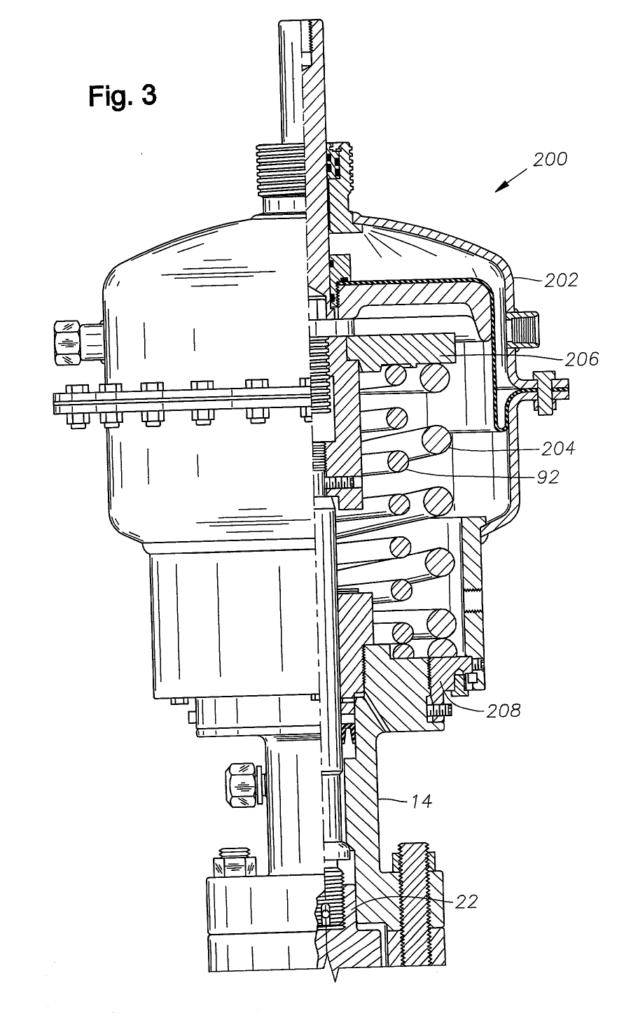

A second embodiment of the present invention is shown in FIG. 3 that allows additional springs to be added to provide additional closing force and facilitate wireline cutting features. Those items which are the same as in the first embodiment retain their numerical designation. Valve actuator 200 comprises actuator housing 202 secured to valve bonnet 14. Actuator housing 202 is the same as in the first embodiment except for being a larger diameter to accommodate booster spring 204 positioned radially outwardly from spring 92. Spring retainer 206 is of the same configuration as in the first embodiment but of a larger diameter to accommodate booster spring 204. The lower end of booster spring 204 rests on mounting ring 208, also sized to allow for the fitting of booster spring 204 and actuator housing 202. In all other respects, valve actuator 200 functions the same as the first embodiment and offers the same unique functional advantages.

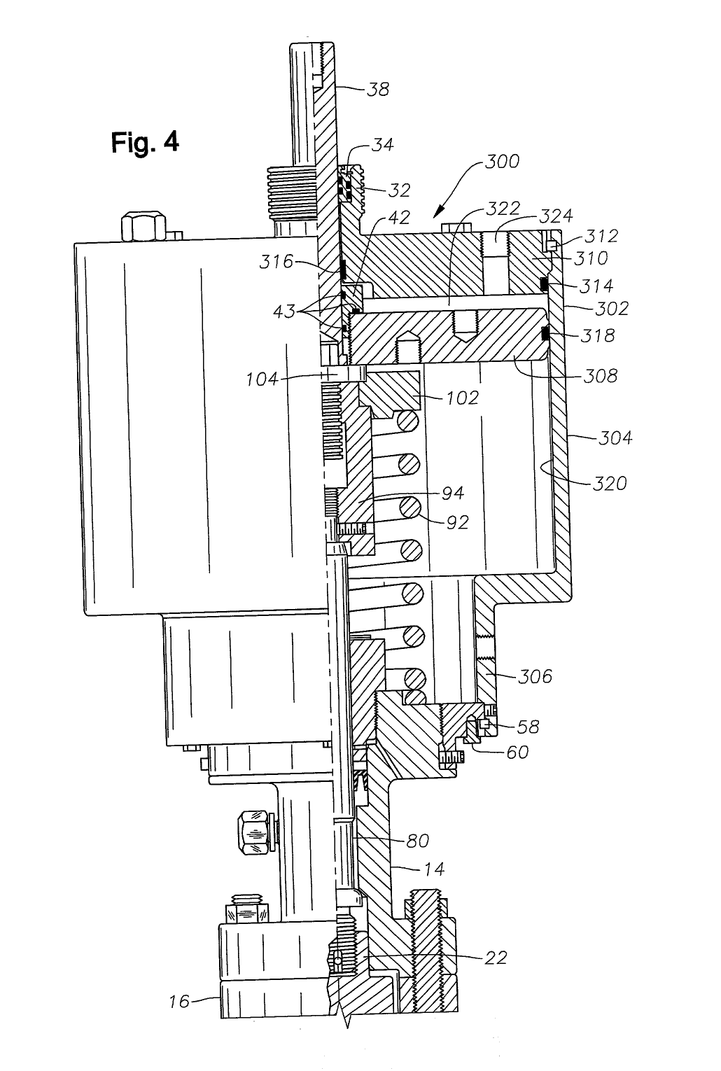

A third embodiment of the present invention is shown in FIG. 4 that uses a pressure responsive piston in place of the flexible diaphragm to provide the opening force. Those items which are the same as in the first embodiment retain their numerical designation. Valve actuator 300 comprises actuator housing 302 secured to valve bonnet 14 in the same manner as in the previous embodiments.

Actuator housing 302 is a generally cylindrical member of stepped configuration with upper section 304 and lower section 306. Upper section 304 is sized to accommodate actuator piston 308. Actuator housing 302 has an open upper end with removable top cap 310 sealingly secured to upper section 304 by split retainer ring 312. Sealing means as O ring 314 is positioned on outside of top cap 310 to seal against upper section 304. Cap nut 32 is integrally formed on top cap 310 and receives seal assembly 34 therein as in the first embodiment. Seal assembly 34 seals against and wear ring 316 guides indicator stem 38 which extends through cap nut 32. Indicator stem 38 is secured to actuator piston 308 by retainer nut 42. Actuator piston 308 has suitable sealing means as O ring 318 positioned on its exterior to seal against interior wall 320 of upper section 304. The combination of actuator piston 308 sealed between upper section 304 and retainer nut 42 and the sealing of retainer nut 42 and top cap 310 to indicator stem 38 forms pressure chamber 322. Actuator piston 308 forms a pressure responsive member that is moveable toward gate valve 16 in response to pressurized fluid, i.e., compressed air introduced into pressure chamber 322 through fluid port 324 machined in top cap 310.

In all other respects, valve actuator 300 functions as in the first embodiment. Actuator housing 302 is secured by retainer ring 58 to mounting ring 60 and hence to valve bonnet 14. Actuator stem 80 extends through valve bonnet 14 where stem adapter 94 is attached. Spring 92 is retained by spring retainer 102 which is held against stem adapter 94 by power screw 104.

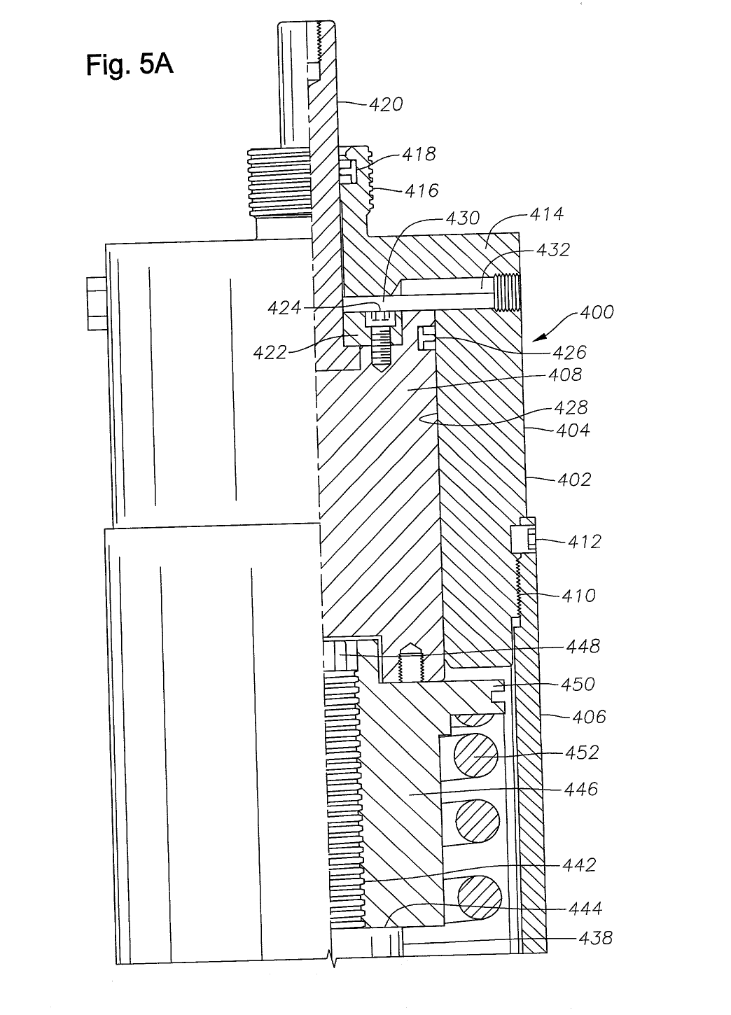

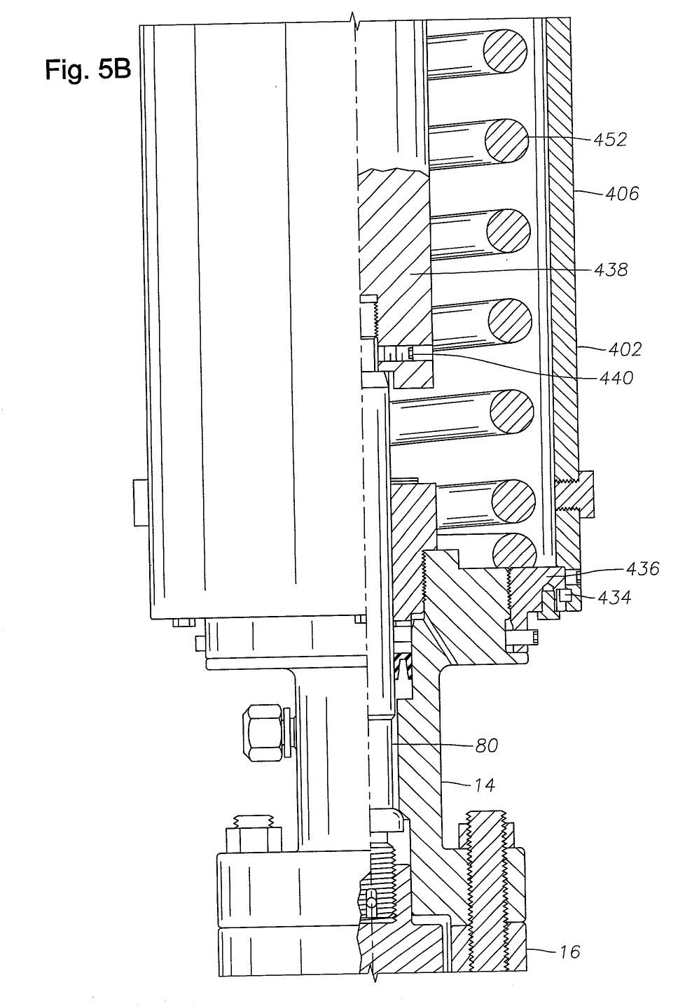

A fourth embodiment of the present invention is shown in FIG. 5 that uses a hydraulically actuated valve actuator in place of the pneumatically actuated valve actuators of the previous embodiments. Those items which are the same as in the first embodiment retain their numerical designation. Valve actuator 400 comprises actuator housing 402 secured to valve bonnet 14 in the same manner as in the previous embodiments.

Actuator housing 402 is a generally cylindrical member of consisting of upper section 404 and lower section 406. Upper section 404 is sized to accommodate actuator piston 408. Upper section 404 and lower section 406 are secured in abutting relationship by threaded joint 410. A plurality of set screws 412 are threaded through lower section 406 to engage upper section 404 and ensure threaded joint 410 does not come loose.

Upper section 404 has a radially inwardly turned flange to form end cap 414. Cap nut 416 is integrally formed on end cap 414 and has suitable sealing means as “T” seals 418 positioned on its interior to seal against indicator stem 420 which extends through cap nut 416. Indicator stem 420 is secured to actuator piston 408 by retainer ring 422 and screws 424. Actuator piston 408 has suitable sealing means as “T” seals 426 positioned on its exterior to seal against interior wall 428 of upper section 404. The combination of actuator piston 408 sealed against upper section 404 and the sealing of retainer nut 416 to indicator stem 420 forms pressure chamber 430. Actuator piston 408 forms a pressure responsive member that is moveable toward gate valve 16 in response to pressurized fluid, i.e., pressurized hydraulic fluid introduced into pressure chamber 430 through fluid port 432 machined in upper section 404.

Actuator housing 402 is secured by retainer ring 434 to mounting ring 436 as in the previous embodiments and hence to valve bonnet 14. Actuator stem 80 extends through valve bonnet 14 where stem adapter 438 is attached. Stem adapter 438 is sized to shoulder against actuator stem 80 and form a rigid connection therebetween. Stem adapter 438 is locked against rotation with respect to actuator stem 80 by set screws 440. Stem adapter 438 has external thread 442 machined therein. The upper exterior of stem adapter 438 has step 444 machined thereon upon which urging means or spring retainer 446 rests. Stem adapter 438 has hex 448 machined on its upper end for engagement by a socket to hold stem adapter 438 to allow threading spring retainer 446 onto external thread 442 of stem adapter 438. Spring retainer 446 has flange 450 formed on its upper end that acts as upper retainer for spring 452. The engagement of spring retainer 446 with thread 442 of stem adapter 438 acts as the power screw of the previous embodiments to allow compression of spring 452 without the use of special tools.

In all other respects valve actuator 400 operates as in the previous embodiments. Introduction of pressurized hydraulic fluid into pressure chamber 430 causes piston 408 to contact spring retainer 446 and thereby compress spring 452. This forces stem adapter 438 and actuator stem 80 to move downwardly thereby opening gate valve 16. As long as pressure is maintained in pressure chamber 430, gate valve 16 will remain open. When pressure is released from pressure chamber 430, spring 452 moves valve gate 22 to its closed position.

The construction of our valve actuator will be readily understood from the foregoing description and it will be seen that we have provided a valve actuator with a fully rotatable connection between the actuator and valve bonnet without the need for bolts that are susceptible to corrosion that allows orienting the valve actuator's pressure supply port in any desired direction without actuator disassembly. Furthermore, while the invention has been shown and described with respect to certain preferred embodiments, it is obvious that equivalent alterations and modifications will occur to others skilled in the art upon the reading and understanding of the specification. The present invention includes all such equivalent alterations and modifications, and is limited only by the scope of the appended claims.

What is claimed is:

1. A valve actuator for moving a valve gate between open and closed valve positions within a valve body, said valve actuator comprising:
an actuator housing defining a pressure chamber therein, said pressure chamber having a fluid port therein;
a pressure responsive member within said actuator housing moveable toward said valve body in response to pressurized fluid introduced into said pressure chamber through said fluid port;
a valve bonnet secured to said valve body, said valve bonnet having a bore there through;
an actuator stem having first and second ends, said actuator stem being axially moveable in said valve bonnet bore, said second end of said actuator stem secured to said valve gate for moving said valve gate between said open and closed valve positions;
an urging means for producing a closing force opposing axial movement of said pressure responsive member toward said valve body;
a stem adapter secured to said first end of said actuator stem, said stem adapter having an outer flange thereon and a threaded recess therein;
an urging means retainer having an inner flange for engagement of said outer flange of said stem adapter to transmit said closing force to said valve stem;
a power screw having a threaded lower end and an external flange, said power screw threaded lower end engaging said stem adapter threaded recess to move said urging means from an uncompressed to an compressed position during assembly;
a securing means connecting said valve bonnet to said actuator housing; and
said actuator housing being resistant to removal from said valve bonnet when said pressure chamber is pressurized.

2. A valve actuator for moving a valve gate between open and closed valve positions within a valve body according to claim 1, said securing means comprising:
an external thread formed on said valve bonnet adjacent said actuator housing;
a mounting ring having an internal thread, said internal thread of said mounting ring engaging said external thread of said valve bonnet;
said actuator housing having upper and lower sections sealingly secured together;
said actuator housing lower section having a counterbore formed therein, said counterbore sized to closely engage the exterior of said mounting ring;
said counterbore of said actuator housing lower section having a retainer groove formed therein; and,
an outwardly biased retainer ring positioned in said retainer groove of said actuator housing lower section, said retainer ring securing said actuator housing to said mounting ring.

3. A valve actuator for moving a valve gate between open and closed valve positions within a valve body according to claim 2, said securing means further comprising:
a support ring positioned adjacent said retainer ring when said retainer ring is outwardly biased, said support ring preventing inward movement of said retainer ring, said support ring secured to said mounting ring by retainer bolts;
a plurality of set screws radially positioned in said mounting ring and engaging said valve bonnet to prevent rotation of said mounting ring relative to said valve bonnet; and,
a plurality of set screws radially positioned in said actuator housing and engaging said mounting ring to prevent rotation of said actuator housing relative to said mounting ring.

4. A valve actuator for moving a valve gate between open and closed valve positions within a valve body according to claim 3, wherein:
said power screw external flange retaining said urging means retainer inner flange in contact with said outer flange of said stem adapter to transmit said closing force to said valve stem.

5. A valve actuator for moving a valve gate between open and closed valve positions within a valve body according to claim 4, wherein:
said valve bonnet having a recess therein to retain said urging means.

6. A valve actuator for moving a valve gate between open and closed valve positions within a valve body according to claim 5, wherein:
said actuator housing being removable from said valve bonnet leaving said valve bonnet intact to hold said valve closed when said actuator housing is removed.

7. A valve actuator for moving a valve gate between open and closed valve positions within a valve body according to claim 6, said pressure responsive member comprising:
a flexible diaphragm mounted within said actuator housing;
said flexible diaphragm responsive to pressurized fluid introduced into said pressure chamber through said fluid port;
said flexible diaphragm attached to a support plate by a retainer nut, said retainer nut sealingly engaging said support plate, said retainer nut having a bore therethrough; and,
said support plate contacting said power screw external flange and moving said valve gate to an open position when said pressure chamber is pressurized.

8. A valve actuator for moving a valve gate between open and closed valve positions within a valve body according to claim 7, further comprising:
an indicator stem, said indicator stem secured to said flexible diaphragm retainer plate by said retainer nut;
said retainer nut sealing against said indicator stem;
a cap nut sealingly secured to said actuator housing upper section;
said indicator stem extending through said cap nut; and,
sealing means secured within said cap nut, said sealing means sealingly engaging said indicator stem.

9. A valve actuator for moving a valve gate between open and closed valve positions within a valve body according to claim 8, wherein:
said urging means is a coil spring.

10. A valve actuator for moving a valve gate between open and closed valve positions within a valve body according to claim 8, wherein:
said urging means is a plurality of coil springs.

11. A valve actuator for moving a valve gate between open and closed valve positions within a valve body according to claim 6, said pressure responsive member comprising:
an actuator piston positioned within said actuator housing;
said actuator piston responsive to pressurized fluid introduced into said pressure chamber through said fluid port;
a removable top cap sealingly secured to said actuator housing; and,
said actuator piston contacting said power screw external flange and moving said valve gate to an open position when said pressure chamber is pressurized.

12. A valve actuator for moving a valve gate between open and closed valve positions within a valve body according to claim 11, further comprising:
an indicator stem, said indicator stem secured to said actuator piston by a retainer nut;
said retainer nut sealing against said indicator stem and said actuator piston;
a cap nut integrally formed on said removable top cap;
said indicator stem extending through said cap nut; and,
sealing means secured within said cap nut, said sealing means sealingly engaging said indicator stem.

13. A valve actuator for moving a valve gate between open and closed valve positions within a valve body according to claim 12, wherein:
said urging means is a coil spring.

14. A valve actuator for moving a valve gate between open and closed valve positions within a valve body according to claim 13, wherein:
said urging means is a plurality of coil springs.

15. A hydraulically actuated valve actuator for moving a valve gate between open and closed valve positions within a valve body, said hydraulically actuated valve actuator comprising:
an actuator housing defining a pressure chamber therein, said pressure chamber having a fluid port therein;
a pressure responsive member within said actuator housing moveable toward said valve body in response to pressurized fluid introduced into said pressure chamber through said fluid port;
a valve bonnet secured to said valve body, said valve bonnet having a bore there through;
an actuator stem having first and second ends, said actuator stem being axially moveable in said valve bonnet bore, said second end of said actuator stem secured to said valve gate for moving said valve gate between said open and closed valve positions;
an urging means for producing a closing force opposing axial movement of said pressure responsive member toward said valve body;
a stem adapter secured to said first end of said actuator stem, said stem adapter having an externally threaded upper end;
an urging means retainer having an internally threaded bore extending therethrough and an outer flange, said internally threaded bore engaging said stem adapter externally threaded upper end to move said urging means from an uncompressed to an compressed position during assembly, said outer flange of said urging means retainer contacting said urging means to transmit said closing force to said valve stem;
a securing means connecting said valve bonnet to said actuator housing; and
said actuator housing being resistant to removal from said valve bonnet when said pressure chamber is pressurized.

16. A hydraulically actuated valve actuator for moving a valve gate between open and closed valve positions within a valve body according to claim 15, said securing means comprising:
an external thread formed on said valve bonnet adjacent said actuator housing;
a mounting ring having an internal thread, said internal thread of said mounting ring engaging said external thread of said valve bonnet;
said actuator housing having upper and lower sections secured together;
said actuator housing lower section having a counterbore formed therein, said counterbore sized to closely engage the exterior of said mounting ring;
said counterbore of said actuator housing lower section having a retainer groove formed therein; and,
an outwardly biased retainer ring positioned in said retainer groove of said actuator housing lower section, said retainer ring securing said actuator housing to said mounting ring.

17. A hydraulically actuated valve actuator for moving a valve gate between open and closed valve positions within a valve body according to claim 16, said securing means further comprising:
a support ring positioned adjacent said retainer ring when said retainer ring is outwardly biased, said support ring preventing inward movement of said retainer ring, said support ring secured to said mounting ring by retainer bolts;
a plurality of set screws radially positioned in said mounting ring and engaging said valve bonnet to prevent rotation of said mounting ring relative to said valve bonnet; and,
a plurality of set screws radially positioned in said actuator housing and engaging said mounting ring to prevent rotation of said actuator housing relative to said mounting ring.

18. A hydraulically actuated valve actuator for moving a valve gate between open and closed valve positions within a valve body according to claim 17, wherein:
said valve bonnet having a recess therein to retain said urging means.

19. A hydraulically actuated valve actuator for moving a valve gate between open and closed valve positions within a valve body according to claim 18, wherein:
said actuator housing being removable from said valve bonnet leaving said valve bonnet intact to hold said valve closed when said actuator housing is removed.

20. A hydraulically actuated valve actuator for moving a valve gate between open and closed valve positions within a valve body according to claim 19, said pressure responsive member comprising:
an actuator piston positioned within said actuator housing;
said actuator piston responsive to pressurized fluid introduced into said pressure chamber through said fluid port;
a top cap integrally formed on said actuator housing upper section; and,
said actuator piston contacting said urging means retainer and moving said valve gate to an open position when said pressure chamber is pressurized.

21. A hydraulically actuated valve actuator for moving a valve gate between open and closed valve positions within a valve body according to claim 20, further comprising:
an indicator stem, said indicator stem secured to said actuator piston by a retainer ring and securing bolts;
a cap nut integrally formed on said integral top cap;
said indicator stem extending through said cap nut; and,
sealing means secured within said cap nut, said sealing means sealingly engaging said indicator stem.

22. A hydraulically actuated valve actuator for moving a valve gate between open and closed valve positions within a valve body according to claim 21, wherein:
said urging means is a coil spring.

23. A hydraulically actuated valve actuator for moving a valve gate between open and closed valve positions within a valve body according to claim 22, wherein:
said urging means is a plurality of coil springs.
